(19) United States
(12) Patent Application Publication
(10) Pub. No.: US 2009/0290624 A1
(43) Pub. Date: Nov. 26, 2009

(54) Programmable jitter generation circuit

(75) Inventors: Jason Thurston, Raleigh, NC (US); Carl Thomas Gray, Apex, NC (US); Terry Perkinson, Cary, NC (US)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/153,801

(22) Filed: May 23, 2008

(51) Int. Cl. H04B 1/38

(52) U.S. Cl. 375/221

(57) ABSTRACT

The present invention provides an integrated circuit comprising a serial transmitter, a serial receiver and a serial connection providing communication between the serial transmitter and the serial receiver. The serial transmitter comprises a clock generator and a serializer for serializing data to be transmitted to the serial receiver. A clock control unit coupled to the clock generator alters the clock phase of the clock signal to stress test the serial receiver.

### FIELD OF THE INVENTION

The present invention relates to stress testing serial receivers. More particularly, this invention relates to stress testing serial receivers by altering the clock phase of serially transmitted data.

### DESCRIPTION OF THE PRIOR ART

It is known to perform tests on serial receivers which receive serialized data over high speed serial links. Such testing, for example shortly after manufacturing, involves artificially down-grading the quality of the signal sent over the serial link with respect to jitter in order to test how well the serial receiver copes with that poor quality data and whether it can still recover the original data that was transmitted. A receiver's ability to cope with such distorted signals is referred to as its jitter tolerance.

Typically, a programmable jitter generator is used to provide the source of the variation in the serial data. The distorted signal used for testing jitter tolerance is commonly referred to as a stressed eye. Such a stressed eye may comprise variation both in the amplitude and the phase of the transmitted signal. Currently, the primary method for testing jitter tolerance is to create a stressed eye off-chip using high speed test equipment. Such equipment may, for example, apply a varying phase to the clock signal used to serialize the data transmitted.

Such high speed test equipment is expensive and complex and hence it is desirable to provide an improved technique for testing serial receivers.

### SUMMARY OF THE INVENTION

Viewed from a first aspect, there is provided an integrated circuit comprising: a serial transmitter; a serial receiver; and a serial connection providing communication between said serial transmitter and said serial receiver, wherein said serial transmitter comprises: a clock generator configured to generate a clock signal, said clock signal having a clock phase relative to a reference clock; a serializer configured to receive and serialize, in dependence on said clock signal, data to be transmitted to said serial receiver; a clock control unit coupled to said clock generator and configured to apply an alteration to said clock phase of said clock signal to stress test said serial receiver.

According to the techniques of the present invention, the creation of a stressed eye for testing a serial receiver is enabled using components which are located on-chip, hence avoiding the need for costly off-chip testing equipment. A clock control unit coupled to a clock generator within a serial transmitter alters the clock phase of the clock signal used by the serial transmitter serializer stress testing the serial receiver. Hence, a simple arrangement for testing the serial receiver is provided, which makes use of hardware that mostly already exists in a serial transmitter. Thus, with minimal additional hardware a simple and easily programmable jitter generator for self-testing on-chip is provided.

The alteration of the clock phase may take a variety of forms. In one embodiment said alteration of said clock phase varies with a characteristic frequency determined by said clock control unit to degrade said communication. In another embodiment said alteration of said clock phase varies in amplitude determined by said clock control unit to degrade said communication. An advantageous range of testing may be carried out by applying an alteration of the clock phase which itself changes in time and/or in amplitude. In one embodiment, the clock control units controls the clock generator by issuing a control signal. It will be appreciated that this control signal can take a variety of forms, but in one embodiment the control signal is a digital control vector.

It will be appreciated by those skilled in the art that the clock signal could be generated in various ways, but in one embodiment the clock generator comprises a phase interpolator to generate the clock signal. By using a phase interpolator this allows the clock generator to generate an output clock signal with a selected phase defined with reference to the phases of the reference clock signals input into the phase interpolator.

When the clock generator uses a phase interpolator to generate the clock signal and the control signal is a digital control vector, in one embodiment the clock generator further comprises a digital to analog converter, the digital to analog converter converting the digital control vector into at least one analog control signal, the at least one analog control signal controlling operation of the phase interpolator. The at least one analog control signal enables a continuously variable output phase of the phase interpolator to be selected.

In another embodiment the clock generator uses a variable delay line when generating the clock signal by varying the amount of delay imposed by the variable delay line. A selected phase of the clock signal output by the clock generator may thus be created.

The control signal issued by the clock control unit may take a variety of forms but in some embodiments of the present invention the control signal is a representation of a modulation pattern, the modulation pattern being one of: a square wave modulation pattern, a triangular wave modulation pattern, a sawtooth modulation pattern, a sinusoidal modulation pattern, and a pseudorandom modulation pattern. These various modulation patterns allow a wide variety of variation in the phase of the clock signal output by the clock generator, hence providing a variety in the testing of the serial receiver.

In another embodiment the clock control unit alters the clock phase of the clock signal by continuously incrementing the clock phase in a predetermined direction. This continual shifting in one direction of the phase of the clock signal effectively creates a frequency offset in the output clock signal. This is particularly useful for testing the tracking ability of the serial receiver.

Viewed from a second aspect, there is provided a method of stress testing a serial receiver on an integrated circuit, comprising the steps of: generating a clock signal in a serial transmitter on said integrated circuit, said clock signal having a clock phase relative to a reference clock; receiving in said serial transmitter data to be communicated over a serial connection on said integrated circuit, said serial connection providing communication between said serial transmitter and said serial receiver; serializing, in dependence on said clock signal, data to be transmitted to said serial receiver; and altering said clock phase of said clock signal to degrade said communication so as to stress test said serial receiver.

According to a third aspect of the present invention, there is provided an integrated circuit comprising: a serial transmitter means for transmitting serial data; a serial receiver means for receiving serial data; and a serial connection means for providing communication between said serial transmitter means and said serial receiver means, wherein said serial transmitter means comprises: a clock generator means for generating a clock signal, said clock signal having a clock phase relative to a reference clock; a serializer means for receiving and serializing, in dependence on said clock signal, data to be transmitted to said serial receiver means; a clock control means coupled to said clock generator means for altering said clock phase of said clock signal to degrade said communication so as to stress test said serial receiver means.

### BRIEF DESCRIPTION OF THE DRAWINGS

The present invention will be described further, by way of example only, with reference to embodiments thereof as illustrated in the accompanying drawings, in which:

FIG. 1 schematically illustrates an integrated circuit according to an example embodiment of the present invention;

FIG. 2 schematically illustrates a clock generator according to an example embodiment of the present invention;

FIG. 3 schematically illustrates example control signals sent from the clock control unit to the clock generator in example embodiments of the present invention; and

FIG. 4 schematically illustrates a control signal varying pseudo-randomly in both clock phase offset and time.

### DESCRIPTION OF THE PREFERRED EMBODIMENTS

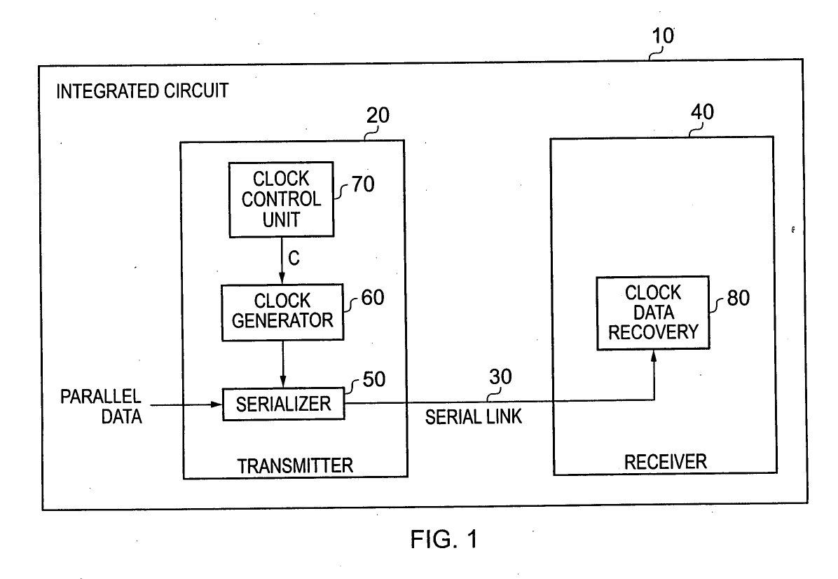

FIG. 1 schematically illustrates an integrated circuit according to one example embodiment of the present invention. Integrated circuit 10 comprises serial transmitter 20, serial link 30 and serial receiver 40. Serial transmitter 20 receives parallel data and serializes it using serializer 50 for transmission on serial link 30 to serial receiver 40. Serializer 50 serializes the data aligned with a clock signal which it receives from clock generator 60. Clock generator 60 generates the clock signal under the control of clock control unit 70. Clock control unit 70 controls clock generator 60 by passing control signal C to clock generator 60. Control signal C causes clock generator 60 to vary the phase of the clock signal it generates. Thus, by means of control signal C, clock control unit 70 causes jitter to be added to the serialized data transmitted on serial link 30. This “stressed eye” signal is used to test the ability of serial receiver 40 to accurately recover the transmitted data, despite the jitter imposed. Serial receiver 40 comprises clock data recovery unit 80 which reconstructs the clock signal embedded in the serial data transmitted on serial link 30. It is the ability of clock data recovery unit 80 to accurately reconstruct this clock signal despite the jitter imposed on the serial data transmitted which at least partially determines whether serial receiver 40 is able to reconstruct the transmitted data.

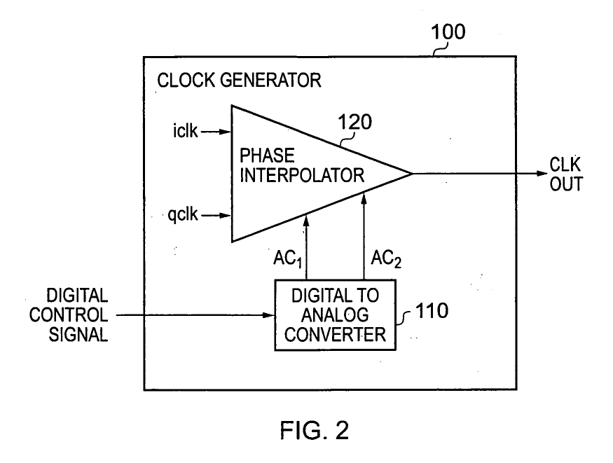

FIG. 2 schematically illustrates a clock generator according to one example embodiment of the present invention. Clock generator 100 receives a digital control signal from clock control unit 70 and generates an output clock signal (CLK OUT), the phase of which is adjusted in dependence upon that digital control signal. The digital control signal is received by the digital to analog converter unit 110 which converts the control signal into two analog control signals, AC₁ and AC₂. These analog control signals are then passed to phase interpolator 120 which generates the clock signal to be output. Phase interpolator 120 receives two input clock signals iclk and qclk. iclk and qclk have a phase difference of 90°. In dependence on analog control signals AC₁ and AC₂, phase interpolator 120 interpolates between the two input clock signals iclk and qclk to generate CLK OUT. AC₁ determines the contribution of iclk and AC₂ determines the contribution of qclk. Thus, under the control of the digital control signal an output clock signal may be generated with any desired phase.

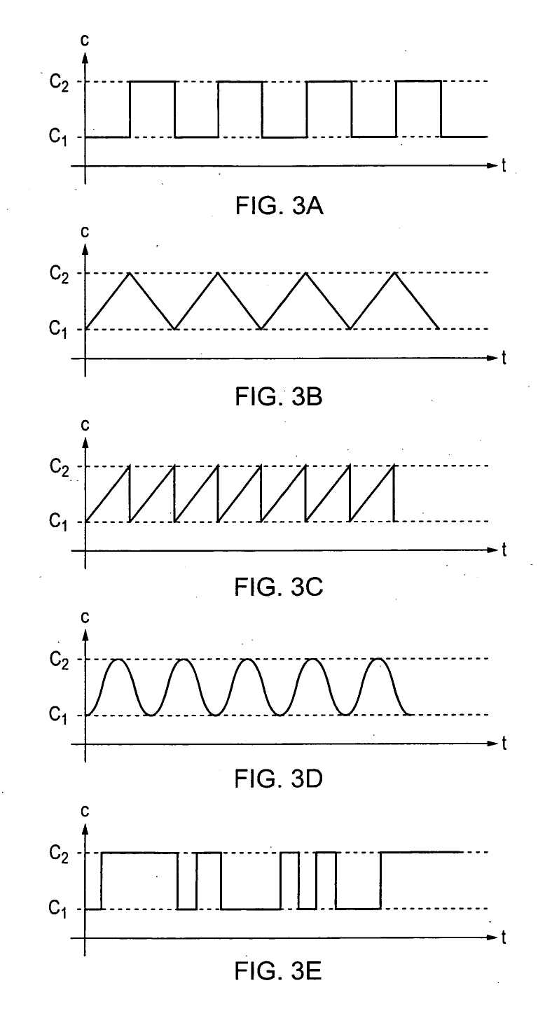

FIG. 3 schematically illustrates various exemplary representations of control signals C with which the clock control unit may steer the clock generator to vary the phase of the clock signal it outputs. In the examples 3A to 3E given, the control signal C varies between a lower limit C₁ and an upper limit C₂. C₁ and C₂ represent arbitrary phase offsets for the clock signal output from the clock generator and it will be recognised that these can represent any values in the full 360° variation possible for the output clock phase. In some embodiments C is an analog control signal whereas in other embodiments it is a digital control signal. In embodiments in which C is a digital control signal, such at that illustrated in FIG. 2, it will be appreciated that rising and falling functions of C such as those illustrated in FIGS. 3B to 3D will in fact be composed of a series of discrete digital steps rather than a smoothly rising or falling value of C (e.g. the rising and falling slopes of FIG. 3B would in fact be composed of staircase incremental upward and downward steps). Some of these functions of C can be seen to have a characteristic frequency and/or amplitude.

FIG. 3A illustrates a square waveform control signal. In this case the output clock signal will abruptly change phase between the phase it has when C=C₁ and the phase it has when C=C₂. FIG. 3B illustrates a control signal with a triangular waveform. In this case the clock phase of the output clock signal will continuously move smoothly between one extreme clock phase value and another, cycling backwards and forwards between the two extremes. FIG. 3C illustrates a control signal with a sawtooth waveform. In this example the clock phase of the output clock signal will steadily move from the clock phase when C=C₁ to the clock phase when C=C₂ at which point it will abruptly jump back to the clock phase when C=C₁. FIG. 3D illustrates a control signal with a sinusoidally varying waveform. In this example the clock phase will also vary sinusoidally between the extreme values of the clock phase when C=C₁ and C=C₂. Finally, FIG. 3E illustrates a control signal with a pseudo-random waveform. In this example the control value C takes either the lower value of C₁ or the upper value of C₂, but the period for which C remains at either of these two values is dictated by a pseudo-random function.

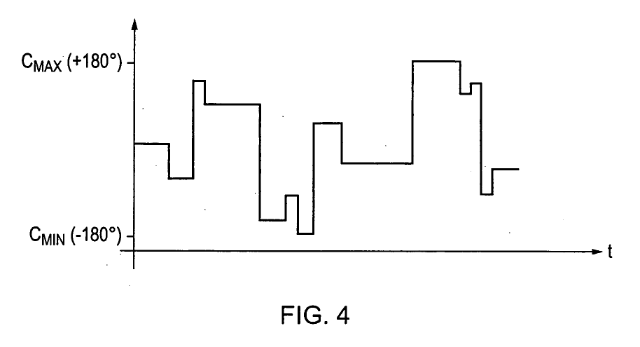

A further pseudo-random control signal is illustrated in FIG. 4. In this example the control signal varies between its two extremes Cₘᵢₙ and Cₘₐₓ which correspond to the maximum phase shifts of −180° and +180°. The pseudo-random function which generates this control signal pattern not only pseudo-randomly varies the value of C and hence the particular clock phase offset applied, but also the duration for which that particular clock phase offset is held.

Thus, according to the present technique, a programmable jitter generation circuit is provided, embodied entirely on-chip, thus avoiding the need to use external off-chip testing facilities to create a stressed eye to test a serial link and the ability of a serial receiver to receive data transmitted over that serial link.

Although particular embodiments of the invention have been described herein, it will be apparent that the invention is not limited thereto, and that many modifications and additions may be made within the scope of the invention. For example, various combinations of the features of the following dependent could be made with the features of the independent claims without departing from the scope of the present invention.

We claim:

1. An integrated circuit comprising:
a serial transmitter;
a serial receiver; and
a serial connection providing communication between said serial transmitter and said serial receiver, wherein
said serial transmitter comprises:
a clock generator configured to generate a clock signal, said clock signal having a clock phase relative to a reference clock;
a serializer configured to receive and serialize, in dependence on said clock signal, data to be transmitted to said serial receiver;
a clock control unit coupled to said clock generator and configured to apply an alteration to said clock phase of said clock signal to stress test said serial receiver.

2. An integrated circuit as claimed in claim 1, wherein said alteration of said clock phase varies with a characteristic frequency determined by the clock control unit to degrade said communication.

3. An integrated circuit as claimed in claim 1, wherein said alteration of said clock phase varies in amplitude determined by the clock control unit to degrade said communication.

4. An integrated circuit as claimed in claim 1, wherein said clock control unit controls said clock generator by issuing a control signal.

5. An integrated circuit as claimed in claim 4, wherein said control signal is a digital control vector.

6. An integrated circuit as claimed in claim 1, wherein said clock generator comprises a phase interpolator to generate said clock signal.

7. An integrated circuit as claimed in claim 6, wherein said control signal is a digital control vector and said clock generator further comprises a digital to analog converter, said digital to analog converter converting said digital control vector into at least one analog control signal, said at least one analog control signal controlling operation of said phase interpolator.

8. An integrated circuit as claimed in claim 1, wherein said clock generator uses a variable delay line when generating said clock signal.

9. An integrated circuit as claimed in claim 4, wherein said control signal issued by said clock control unit is a representation of a modulation pattern, said modulation pattern being one of:
a square-wave modulation pattern;
a triangular-wave modulation pattern;
a saw-tooth modulation pattern;
a sinusoidal modulation pattern; and
a pseudo-random modulation pattern.

10. An integrated circuit as claimed in claim 1, wherein said clock control unit alters said clock phase of said clock signal by continuously incrementing said clock phase in a predetermined direction.

11. A method of stress testing a serial receiver on an integrated circuit, comprising the steps of:
generating a clock signal in a serial transmitter on said integrated circuit, said clock signal having a clock phase relative to a reference clock;
receiving in said serial transmitter data to be communicated over a serial connection on said integrated circuit, said serial connection providing communication between said serial transmitter and said serial receiver;
serializing, in dependence on said clock signal, data to be transmitted to said serial receiver; and
altering said clock phase of said clock signal to stress test said serial receiver.

12. An integrated circuit comprising:
a serial transmitter means for transmitting serial data, a serial receiver means for receiving serial data; and
a serial connection means for providing communication between said serial transmitter means and said serial receiver means, wherein
said serial transmitter means comprises:
a clock generator means for generating a clock signal, said clock signal having a clock phase relative to a reference clock;
a serializer means for receiving and serializing, in dependence on said clock signal, data to be transmitted to said serial receiver means;
a clock control means coupled to said clock generator means to apply an alteration to said clock phase of said clock signal to stress test said serial receiver means.
